(19) United States
(12) Patent Application Publication
(10) Pub. No.: US 2019/0112939 A1
(43) Pub. Date: Apr. 18, 2019

(54) FLUID SEAL

(71) Applicant: ROLLS-ROYCE plc, London (GB)

(72) Inventor: Rudi Oliver KIRNER, Bristol (GB)

(73) Assignee: ROLLS-ROYCE plc, London (GB)

(21) Appl. No.: 16/128,965

(22) Filed: Sep. 12, 2018

(30) Foreign Application Priority Data
Oct. 17, 2017 (GB) 1717015.0

(51) Int. Cl. F01D 11/08; F01D 5/20; F01D 9/00

(52) U.S. Cl. CPC F01D 11/08; F01D 5/20; F01D 9/00; F05D 2250/71; F05D 2240/307; F05D 2240/55; F05D 2240/11; F05D 2220/32

(57) ABSTRACT

This invention concerns a flow seal (42) for location between opposing components of a fluid flow machine, such as rotor (44) and stator (46) components of a turbomachine (10). The seal (42) has an upstream fin (24) depending from one of components (44) towards an opposing surface (28) of the other (46) of the components and a wall (26) downstream of the fin (24) defining a flow cavity between the fin (24) and wall (26). The fin (24) terminates at a fin tip (24A) so as to define a gap between the fin tip (24A) and the opposing surface (28), through which a leakage flow enters the flow cavity in use. The seal (42) also has a flow guide member (30A) located in the cavity, the flow guide member (30A) being arranged to define a flow path that promotes a vortical flow regime in the cavity. The flow cavity geometry is altered to promote a desired vortical flow regime, such as by way of a projection (39) in an intermediate wall portion of the flow cavity. The vortical flow regime may hinder flow leakage.

### CROSS-REFERENCE TO RELATED APPLICATIONS

This specification is based upon and claims the benefit of priority from UK Patent Application Number GB1717015.0 filed on Oct. 17, 2017, the entire contents of which are incorporated herein by reference.

### BACKGROUND

### Field of the Disclosure

The present disclosure concerns fluid seals for fluid flow machines such as, for example, turbomachinery, compressors, pumps, turbines and the like.

### Description of the Related Art

Sealing an interface between rotor and stator components against flow leakage is a known problem and there exist a number of seal designs in the prior art. Flow leakage is an important consideration in flow-driving machinery, such as pumps and compressors, where it is desirable to maintain a positive internal fluid pressure within an internal cavity of the machine.

For a gas turbine engine it is known that the total specific fuel consumption (SFC) benefit on achieving optimum seal clearances throughout the engine's air system can be significant. Improved sealing technology can therefore make an important contribution to meeting future engine efficiency improvement targets.

FIG. 1 shows an example of a conventional labyrinth seal 2 that is currently used in gas turbine engines. The seal 2 comprises five fins 4 in flow series that operate to restrict the leakage flow between the rotor 6 and stator 8. The flow travelling towards each fin 4 accelerates as the cross sectional area reduces. The flow separates over the fin tips and causes the kinetic energy associated with the increased flow velocity to be dissipated by entropy, which drives the total pressure loss. This process is repeated as the flow enters each successive region confined between adjacent fins 4.

In the stepped geometry example, total pressure loss producing vortices are induced by the flow separation over the fins and are augmented by the stepped geometry. The stepped geometry acts to enhance the diffusion of the flow once it travels through the gap between the upstream fin and the stator before reaching the next fin.

US2009297341 discloses various examples of fin seal for turbomachinery in which a flow channel is used to divert a portion of the flow against a main flow direction through the seal to disrupt the main/leakage flow through the seal. The diverting flow channel thus acts as a flow diode. The flow diode arrangements of US2009297341 require geometrical changes to existing seals or rotor/stator components, which may already be optimised for more conventional seal efficiency.

It has been found by the inventor that the fluid mechanics of the disrupting flow diode are not optimal and in some respects potentially contrary to a desirous flow regime through a labyrinth seal of the kind shown in FIG. 1.

It is an aim of the present disclosure to provide a fluid seal for rotating machinery offering alternative and/or improved fluid mechanics to promote sealing.

### SUMMARY

According to a first aspect of the disclosure, there is provided a flow seal for location between a first component and a second component of a fluid flow machine. The flow seal may comprise a flow cavity formed between an upstream fin and a downstream wall. The upstream fin may extend from the first component towards an opposing surface of the second component and terminates at a fin tip to define an upstream inlet gap through which, during use, a leakage fluid enters the cavity. The downstream wall may be configured downstream of the fin and may extend from one of components towards an opposing surface of the other of the components to define a downstream outlet gap through which, during use, the leakage fluid exits the cavity. The seal may further comprise a flow guide member configured within the cavity to define, in use, a leakage fluid flow path that both promotes vortical flow of the leakage fluid within the cavity, and directs the leakage fluid towards the upstream inlet gap to at least partially reduce the quantity of leakage fluid entering the cavity.

The flow guide member may arranged to define a flow path that interacts with the flow at the fin tip so as to reduce effective clearance.

The cavity may be immediately downstream of, or adjacent, the fin. The fin may define a side wall of the cavity. The cavity may have a depth/height dimension and/or width dimension that is greater, e.g. significantly greater, than that of the gap.

Any or any combination of the fin, flow guide member and/or wall may comprise an annular body or formation extending around an axis of rotation of the fluid flow machine or a rotor thereof.

The wall may comprise a downstream fin or wall section of the opposing surface, e.g. a profiled or curved surface at least partially surrounding the cavity, vortical flow and/or flow guide member.

The flow path may or may not be curved, e.g. to promote vortical flow exiting the flow path.

The flow path may be formed between the flow guide member and the fin and/or wall. The flow guide member may be correspondingly shaped with the fin and/or wall. The flow guide member may be adjacent the fin and/or wall, e.g. to define a narrow leakage fluid flow path relative to the width of the cavity. The width of the flow path may be less than or equal to ½, ⅓, ¼ or ⅕ the width of the flow cavity.

The flow guide member and/or flow path may be elongate, e.g. in section.

According to a second aspect of the disclosure there is provided a flow seal for location between opposing components of a fluid flow machine, the flow seal comprising a plurality of adjacent fins depending from a common support structure of one of the components towards an opposing surface of the other component, each fin terminating at a fin tip so as to define an upstream inlet gap and a downstream outlet gap. Fluid flow through the upstream inlet gap may, in use, causes flow separation resulting in a vortical flow in a flow cavity between the adjacent fins. The flow seal may further comprise a flow guide member configured within the cavity between the adjacent fins to define a leakage fluid flow path that, in use, either or both of promotes vortical flow of the leakage fluid within the cavity, and directs the leakage fluid towards the upstream inlet gap to at least partially reduce the quantity of leakage fluid entering the cavity.

The flow guide member may be spaced from either or both of the adjacent fins so as to define a flow path/channel between the flow guide member and at least one fin. The leakage fluid flow path may be defined between the flow guide member and a downstream fin or wall. The flow guide member may narrow towards its outlet.

An inlet or upstream end of the flow path/guide member may be offset, e.g. radially, from an outlet or downstream end of the flow path/guide member. An inlet or upstream end of the flow path/guide member may be spaced in a direction in which the at least one fin extends from an outlet or downstream end of the flow path/guide member.

The flow seal may comprise a profiled intermediate surface between adjacent fins or between the fin and wall. The intermediate surface may be curved, e.g. defining a curved/profiled flow cavity.

The intermediate surface may comprise an apex or discontinuity.

The flow guide member may be correspondingly profiled, e.g. to follow a profile of the intermediate surface and/or the adjacent fin/wall. The flow guide member may be curved at least in part.

The flow seal may be a gas seal, e.g. for sealing a gas/air chamber of the flow machine. The chamber may be pressurised/depressurised, e.g. by operation of the flow machine.

The opposing components may be arranged to undergo relative movement in use. At least one of the components may comprise a rotor. The other component may comprise a rotor or stator.

The fluid flow machine may comprise turbomachinery. The flow machine may comprise a gas turbine engine or subassembly thereof.

The opposing surface (e.g. in the stator) may be profiled. The opposing surface (e.g. in the stator) may comprise a step formation. The step may be located part way along the flow cavity, e.g. between the upstream fin and downstream fin/wall. A series of steps in the opposing surface may be provided.

The opposing surface may be profiled so as to promote the vortical flow in the cavity. The opposing surface may or may not be curved, e.g. through an angle of greater than 90° or 120°. The opposing surface may or may not be curved towards an apex, tip or point. The opposing surface may be curved towards the flow guide member, flow path (e.g. an inlet end thereof), fin or wall, e.g. to direct flow there-towards.

The opposing surface may at least partially surround the flow guide member and/or the downstream fin of the adjacent fins. The opposing surface may turn through an angle of at least 90°, 120°, 150° or 180° or more around the flow guide member and/or downstream fin.

The fins may be arranged in a stepped configuration. Each fin may be offset, e.g. by a radial distance, relative to the adjacent fin.

A series of three or four or more fins may depend from the common support. The flow guide member may be located between the final two adjacent fins of the series of fins in the flow direction or between the final fin and the downstream wall.

The fin or wall may comprise an inner surface, e.g. facing the flow cavity. The inner surface may be concave in profile. The downstream fin may comprise an opposing outer surface. The outer surface may be curved in profile. The outer surface may be convex in form. The outer surface may be downstream of the inner surface in the flow direction (e.g. the global or leakage flow direction) through the flow seal.

The opposing surface may be curved around the outer surface of the downstream fin, e.g. so as to define a flow path between the opposing surface and the outer surface of the downstream fin.

The opposing surface may pass/extend beneath the downstream fin or flow guide member, e.g. beneath the common support. The opposing surface may pass at least part-way along an underside of the common support. The opposing surface may be shaped to define a recess in which the downstream fin is located. The opposing surface and common support may partially overlap. A gap between the opposing surface and the underside of the common support may define an outlet from the flow seal, e. g for flow downstream of the downstream fin.

The flow guide member may have a width dimension that is less than the width of the cavity, e.g. between the adjacent fins.

The flow guide member may have a height dimension that is less than or approximately equal to the height of the downstream fin/wall.

The flow guide member may comprise a flow diode.

The upstream fin may have a ramped or sloped downstream surface, e.g. obliquely angled from a wider base towards a narrower tip. Either or both of the adjacent fins may be tapered.

The upstream fin may have a forward/upstream lean, e.g. towards its tip. An upstream surface of the upstream fin may be forward sloping, e.g. leaning forward/upstream in the flow direction. The upstream and downstream surfaces of the upstream fin may be obliquely angled, e.g. with the downstream surface leaning forward to a greater extent than the upstream surface.

The downstream fin may have a forward/upstream lean, e.g. towards its tip.

The flow path may be shaped to at least partially surround the vortical flow in said cavity

Fluid flow through the gap may causes flow separation resulting in a vortical flow in said cavity, e.g. which is promoted by the flow guide member.

According to a third aspect of the disclosure, there is provided a flow seal for location between opposing components of a fluid flow machine. The flow seal may comprise a first component of the flow seal having an upstream fin, a downstream fin and an intermediate surface extending between the upstream and downstream fins. The upstream and downstream fins may extend from the intermediate surface towards an opposing surface of a second component of the flow seal. The upstream and downstream fins may terminate at respective fin tips so as to define an upstream inlet gap and a downstream outlet gap between the respective fin tips and the opposing surface, such that a leakage fluid flowing through the flow seal passes through each said gap in use. The opposing surface may comprise a flow diverting formation configured between the upstream and downstream fins of the first component to divert the leakage fluid towards the intermediate surface. The intermediate surface may comprise a corresponding formation that, in use, either or both of promotes vortical flow of the leakage fluid in the space between the upstream and downstream fins, and directs the leakage fluid towards the upstream inlet gap to at least partially reduce the quantity of leakage fluid entering the cavity.

The corresponding formation may comprise an apex, tip, or projection from the intermediate wall/surface, e.g. extending part way into a flow cavity defined between the upstream and downstream fins. The corresponding formation may comprise a sharp discontinuity in the intermediate surface.

The intermediate surface may be curved. An upstream side of the downstream fin may be curved towards the upstream fin. The intermediate surface may be curved in an opposing direction to the upstream side of the downstream fin.

A downstream side of the upstream fin may be curved. The intermediate surface may be curved in an opposing direction to the downstream side of the upstream fin.

The intermediate surface may be curved/sloped on either side of the formation. The intermediate surface may be opposingly curved/sloped towards the formation on opposing sides thereof.

The flow diverting formation may comprise an apex/corner pointing towards the corresponding formation of the first component, e.g. which may comprise an acutely angled apex/corner.

The flow diverting formation may or may not be curved in profile, e.g. having a curved face facing the upstream gap. The flow diverting formation may comprise a step.

According to a further aspect of the disclosure, there is provided a flow machine, e.g. an axial flow machine, comprising the seal of the first, second or third aspect. The flow machine may comprise a compressor, a turbine, a gas turbine engine or a subassembly thereof.

The skilled person in the art will understand that any of the essential or preferable features defined in relation to any one aspect of the disclosure may be applied to any further aspect, where practicable. Accordingly the invention may comprise various alternative configurations of the features defined above.

### BRIEF DESCRIPTION OF THE DRAWINGS

Practicable embodiments are described in further detail below by way of example only with reference to the accompanying drawings, of which:

FIG. 1 shows a schematic section view through a seal portion of a conventional rotor and stator assembly;

FIG. 2 shows a schematic longitudinal half-section through a gas turbine engine;

FIG. 3 shows a schematic section view through adjacent fins of a seal according to a first example of the present disclosure;

FIG. 4 shows a schematic section view through adjacent fins of a seal according to a second example the present disclosure;

FIG. 5 shows a schematic section view through adjacent fins of a seal according to a third example the present disclosure;

FIG. 6 shows a section view through a labyrinth seal according to the example of FIG. 5;

FIG. 7 shows a computational fluid dynamics flow field simulation through the sectional geometry of the final step in a labyrinth seal according to the third example of FIGS. 5-6;

FIG. 8 shows a section view through a labyrinth seal with flow guide members in a plurality of cavities of a common labyrinth seal;

FIG. 9 shows a schematic section view through a seal according to a further example the present disclosure;

FIG. 10 shows a schematic section view through adjacent fins of a seal according to a further example the present disclosure; and,

FIG. 11 shows a schematic section view through a seal having a plurality of guides according to a further example the present disclosure.

### DETAILED DESCRIPTION OF THE DISCLOSURE

Turning now to FIG. 2, a gas turbine engine is generally indicated at 10, having a principal and rotational axis 11. The engine 10 comprises, in axial flow series, an air intake 12, a propulsive fan 13, an intermediate pressure compressor 14, a high-pressure compressor 15, combustion equipment 16, a high-pressure turbine 17, an intermediate pressure turbine 18, a low-pressure turbine 19 and an exhaust nozzle 20. A nacelle 21 generally surrounds the engine 10 and defines both the intake 12 and the exhaust nozzle 20.

The gas turbine engine 10 works in the conventional manner so that air entering the intake 12 is accelerated by the fan 13 to produce two air flows: a first air flow into the intermediate pressure compressor 14 and a second air flow which passes through a bypass duct 22 to provide propulsive thrust. The intermediate pressure compressor 14 compresses the air flow directed into it before delivering that air to the high pressure compressor 15 where further compression takes place.

The compressed air from the high-pressure compressor 15 is directed into the combustion equipment 16 where it is mixed with fuel and the mixture combusted. The resultant hot combustion products then expand through, and thereby drive the high, intermediate and low-pressure turbines 17, 18, 19 before being exhausted through the nozzle 20 to provide additional propulsive thrust. The high 17, intermediate 18 and low 19 pressure turbines drive respectively the high pressure compressor 15, intermediate pressure compressor 14 and fan 13, each by a suitable interconnecting shaft.

Other gas turbine engines to which the present disclosure may be applied may have alternative configurations. By way of example, such engines may have an alternative number of interconnecting shafts (e.g. two) and/or an alternative number of compressors and/or turbines. Further the engine may comprise a gearbox provided in the drive train from a turbine to a compressor and/or fan.

This disclosure concerns seals used to seal internal cavities/chambers, for example, within a gas turbine engine of the type shown in FIG. 2, such as at an interface between a rotor of a compressor/turbine and an adjacent stator structure, such as a housing or casing. Whilst the invention was derived for such rotating machines, it will be appreciated by the skilled person that there are other scenarios in which such a type of seal may be used, e.g. in which opposing components are arranged to undergo longitudinal, rather than rotational, movement or in which components are arranged to either accommodate a tolerance, resulting in a flow gap, or else undergo relatively small movement in use, e.g. due to thermal expansion, creep or other loading scenarios. In any such applications, the seal may be characterised as a non-contact fluid seal in that it aims to minimise flow through the seal, whilst allowing a gap between the opposing components.

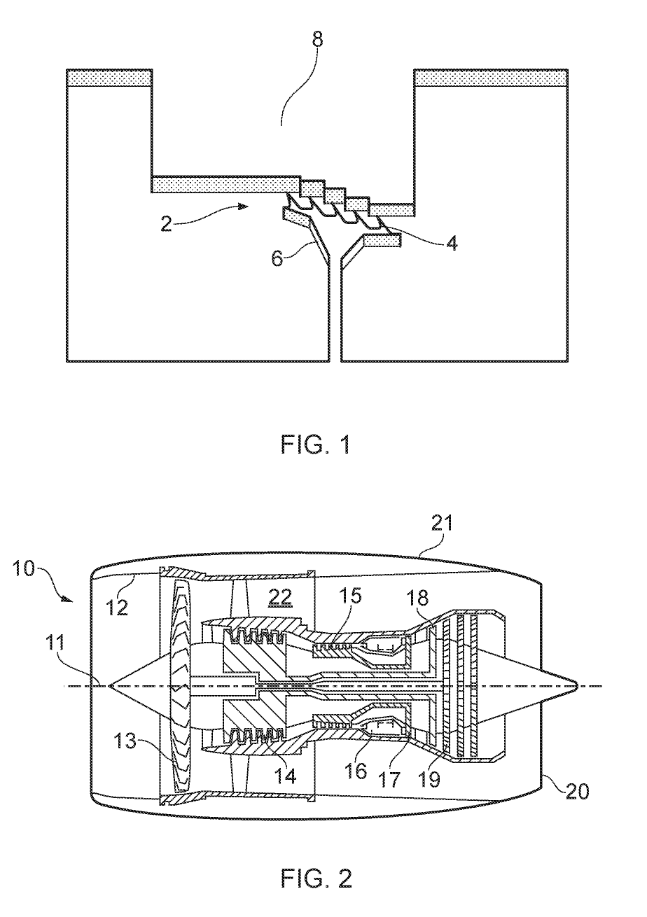

The present disclosure results from the realisation that it is possible to insert a flow guide member or other flow diverting formation in-between the adjacent fins 4 of a labyrinth seal 2 of the kind shown in FIG. 1 to promote a flow regime between the fins that reduces leakage flow through the seal. The present disclosure proceeds in relation to gas (i.e. air) seals for preventing leakage of pressurised/heated air from within the engine

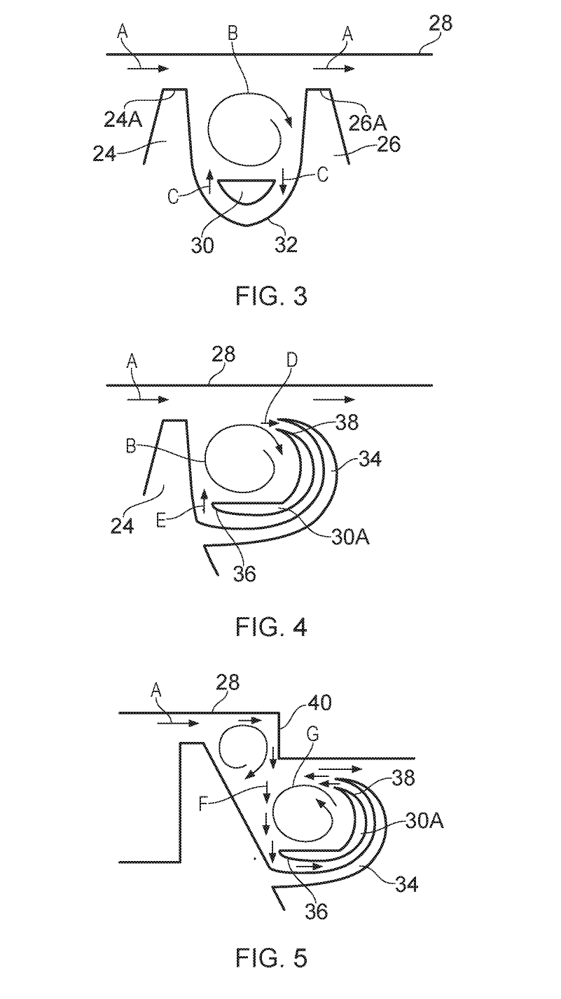

Turning now to FIG. 3, two fins 24, 26 are shown, each having a respective fin tip 24A and 26A. The fins 24, 26 extend towards an opposing surface 28 but terminate a short distance from the opposing surface so as to define a gap between the fin tips 24A and 26A and the surface 28, which serves as a leakage flow gap.

The general leakage flow direction through the seal is shown by arrows A, e.g. following the general direction of the surface 28. Thus the fin 24 can be defined as an upstream fin and the fin 26 can be defined as a downstream fin. Similar reference to the direction of leakage flow and relative upstream and downstream locations is used for all examples of the disclosure. Thus, in some examples, the gap between fin tip 24A and the surface 28 is defined as an upstream inlet gap. In some examples, the gap between fin tip 26A and the surface 28 is defined as a downstream inlet gap.

However it will be appreciated by the skilled person that local disturbances in the flow may depart from the global leakage flow direction. The flow accelerates through the gap between the fin tips 24A, 26A and opposing surface 28 due to the reduced flow. The narrow tips 24A and 26A and the orientation of the upstream and/or downstream fin surfaces causes flow separation as the flow passes over the upstream fin 24. This flow separation causes a vortical/swirling component of the flow in the recess between the upstream 24 and downstream 26 fins as shown by arrow B, i.e. a clockwise vortex as shown in FIG. 3.

In the example of FIG. 3, a flow guide 30 in the form of a diode is located in between the fins 24 and 26. According to examples of the disclosure, the flow diode takes the form of an island in section such that flow can pass completely around the guide 30 in the recess/space between the adjacent fins. The diode may comprise at least one curved surface and one flat planar surface as would be understood by the skilled person to achieve the one-way flow diode effect in conjunction with the intermediate curved wall portion 32 between the fins 24, 26.

The flow guide is shaped and oriented to cause flow in the direction of arrows C. This therefore causes a circulatory flow in the direction of arrows C about the flow guide 30, which promotes the flow direction B of the main vortex between the fins. Whilst this may provide some alteration to the vortical flow B, the benefits of bleeding flow around flow guide 30 are not optimised since the region of the vortex B from which the flow is drawn around the flow guide 30 is at a similar pressure to the region of the vortex B in which the flow C is returned. The flow losses would be generally increased in this example due to friction losses. Accordingly the principle of the flow guide 30 provides one example of the present disclosure but is further optimisable as described below.

In FIG. 4 the concept is developed further by providing a flow guide 30A of modified shape. The flow guide 30A still acts as a diode but has been elongated in form to extend from an upstream end 36 close to the base of upstream fin 24 to a downstream end 38 close to the tip 34A of downstream fin 34. The flow guide 30A turns through an angle of at least 90° in this example within the confines of the upstream and downstream fins according to aspects of the disclosure. However the flow guide may turn through less than 90° in other examples.

The flow guide 30A is curved in form in that at least the outer surface of the flow guide facing the downstream fin 34 is curved.

In the example of FIG. 4, the downstream fin 34 shape has been modified compared to the downstream fin 26 of FIG. 3. In particular the downstream fin 34 has opposing upstream/inner and downstream/outer surfaces that follow a curved path. The curved upstream surface, in conjunction with the flow guide 30A provide a curved vortex-inducing flow path in the clockwise direction D, which is in the same sense as the main vortex B caused by the leakage flow A.

The curved upstream surface of the fin 34 may turn through an angle of at least 90°. Either or both of the fin 34 and flow guide 30A may have a convex outer/first surface and a concave inner/opposing surface. Either or both of the fin 34 and flow guide 30A may be generally crescent-shaped, sickle-shaped or kidney-shaped.

The flow guide is referred to as a ‘circulator’ since it follows a path around a vortical flow D from an inlet at its upstream end 38 to an outlet at its downstream end 36. This circulator bleeds power from the vortex B and main bulk leakage flow A and increases pressure loss through the passage.

The flow guide inlet and outlet ends occur in different pressure regions of the vortex B.

The flow regime caused by circulator flow guide 30A can potentially be improved for certain seal designs, since the bulk vortical flow vector B and the circulator outlet flow E feeds the bulk leakage direction A, rather than promoting the vortex in favour of (i.e. to the detriment of) the bulk leakage flow. Thus the benefits of the flow guide 30A can be further optimised in a stepped labyrinth seal design as shown in FIG. 5.

In the examples of FIGS. 5-7, the provision of a step 40 in opposing surface 28 is used to help re-orient the main leakage flow A relative to the flow guide 30A. The step 40 represents a step change in geometry in the radial direction so as to divide the opposing surface 28 into a radially outer section upstream of the step 40 and a radially inner section downstream of the step.

The step 40 alters the bulk flow vector towards the inlet end 36 of the flow guide 30A in use as shown by arrows F. Thus the flow guide 30A is fed a greater proportion of the leakage flow A and drives the vortical flow G between the fins to a greater extent. The vortical flow G is thus in the reverse direction to the vortex B in FIGS. 3 and 4, i.e. an anticlockwise direction as shown in FIG. 5.

The circulator flow in FIG. 5 thus enhances the vortex, e.g. due at least in part to the injection of flow into a weak pressure region of the vortex. The opening/flow area at the flow passage exit may be controlled/reduced enabling higher momentum and assisting vortex flow turning. An additional or alternative potential beneficial effect of this is the higher passage flow momentum and increased upstream angle relative to the fin geometry, which may enhance flow separation over the fin tip and reduce the effective flow area between the fin and stator wall.

In summary of FIGS. 3-5, the examples of the disclosure may be considered to comprise any or any combination of:
A sufficiently small diode geometry for location between adjacent fins;
Shaping the diode to at least partially encapsulate the vortex between fins
Orienting the diode to feed a weaker vortex region
Modifying the downstream fin shape to partially surround the diode
Positioning a step geometry to feed the diode inlet

Any or any combination of the above features may be implemented with the aim of enhancing/promoting, rather than disrupting, the vortical flow between the fins and/or increasing fin tip flow separation due to an increased flow angle upstream relative to the fin tip. The enhanced vortical flow may obstruct leakage flow passing through the seal.

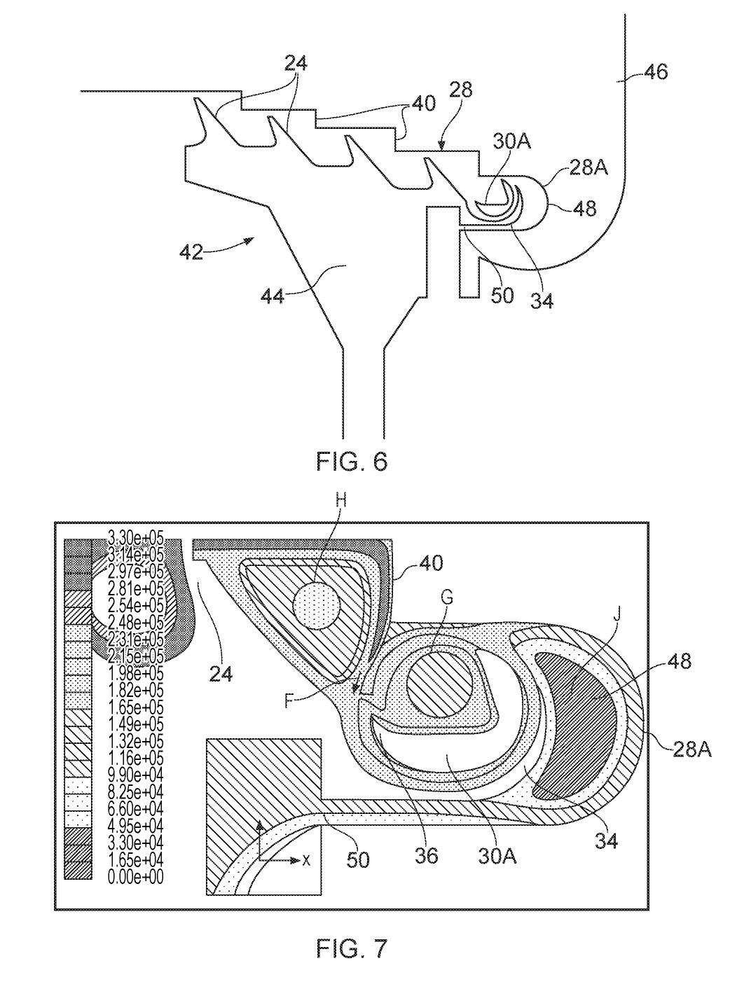

Turning to FIG. 6 an example of a seal 42 is shown with a plurality of fins 24 on a common supporting body 44, which in this example comprises the rotor portion of the machine. The seal 42 comprises a stepped labyrinth seal, with steps 40 in the opposing surface 28 of the static casing 46 arranged between adjacent pairs of fins 24.

The circulator flow guide 30A is provided between the final/downstream pair of adjacent fins and the geometry of the final fin 34 is modified in the manner described above. In other examples, the flow guide 30A and/or modified fin geometry 34 could be provided at other locations in the series of fins, i.e. between an upstream or mid pair of fins, and need not be isolated to the downstream pair of fins of the seal 42. A plurality of flow guides 30A could be provided between different pairs of adjacent fins. In one example, a flow guide 30A could be provided between every pair of adjacent fins of the seal.

In the example of FIG. 6, the geometry of the opposing surface 28 of the stator/casing 46 is modified in region 28A to surround the downstream fin 34. The opposing surface is curved around the fin 34 so as to define a recess 48 in which the fin 34 is mounted. The shape/curvature of the opposing surface defining the recess 48 may be as described above in relation to the fin 34 or flow guide 30A.

The recess 48 defines a flow passage for flow exiting the seal over the downstream fin 34, i.e. a curved flow passage over the outer/downstream surface of fin 34. The flow passage may be generally curved, crescent-shaped or sickle-shaped in section.

The opposing surface region 28A passes around the fin 34 and then beneath (i.e. radially inside) the fin 34 to define a seal outlet 50. The region of the opposing surface beneath the fin 34 may be straight so as to define an axially extending flow passage portion. Thus the recess 48 provides a flow cavity leading to the narrower flow passage towards the outlet 50. This arrangement, particularly the constriction in flow area leaving the seal 42 may further enhance the sealing action.

The result of a computational fluid dynamics simulation of flow through a section of the geometry shown in FIG. 6 is shown in FIG. 7. It can be seen that the step geometry 40 in conjunction with the upstream fin 24 creates a first vortex H that is radially offset from the vortex G induced by the flow guide 30A. The vortex H feeds the flow to the inlet end 36 of flow guide 30A and thus drives the vortex G.

The vortexes H and G are opposingly-handed (i.e. swirling in opposing directions). The flow F feeding the flow guide 30A thus travels along the interface between the opposingly rotating vortices G and H. The flow direction of the vortices G and H is thus aligned in the region of arrow F. This feeds the flow through the circulator promoting the radially-inner vortex G between the fins. Any flow exiting the seal over the fin 34 must turn over the sharp corner around fin 34 tip and into recess 48. Thus a significant portion of the flow recirculates and drives the energy losses within the flow vortex, whilst the remainder of the flow bleeds out from the vortex over the fin and exhausts from the seal via the rotor/stator gap.

The specific design described above locates the inlet of the circulator flow passage in line with the high velocity part of the flow F that has lost little energy to the first vortex H.

It can also be seen that, whilst a portion of the flow through the recess 48 follows the wall section 48, at least some of the flow generates a further vortex J within the recess. It is possible that a further obstruction, such as a baffle, small step or lip could be provided in the surface section 28A to cause separation of the flow in the recess 48, thereby further restricting leakage flow loss by inducing further losses in the exit flow.

The exit flow from recess towards outlet 50 then passes into a downstream cavity 52 of greater cross-sectional area where it diffuses and slows.

The flow velocity profile of FIG. 7 can be compared to a corresponding flow velocity profile for the baseline seal shown in FIG. 1 to show significant improvements in resulting flow characteristics such as the total pressure and velocity vectors. The potential reduction in leakage flow that may be achieved for optimal axial displacements, compared to a conventional seal as shown in FIG. 1, is believed to be greater than 5%, 10% or even 15%. With ongoing routine design refinements and optimisation, it is proposed that these leakage flow savings could potentially be increased. It is also noted that there may be benefit in having reduced sealing at non-optimal axial displacement, e.g. for potentially tailoring the leakage to engine condition via axial displacements.

The circulator flow guide enables the flow to circulate around the cavity between adjacent fins and direct itself back into the cavity, i.e. from the downstream side of the cavity. Depending on the axial closure of the rotor to stator, this exit path could be optimised to augment the circulator flow guide performance.

Since the rotor, e.g. for a gas turbine engine implementation, could be rotating at up to 18000 rpm, a radial pump is produced by the centrifugal action of the shear flow next to the rotor.

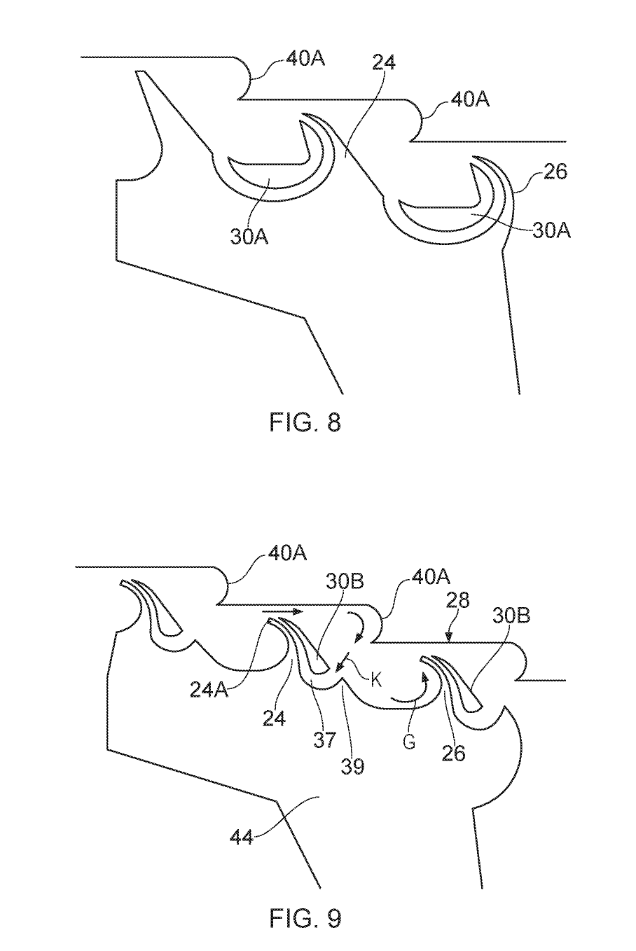

FIG. 8 shows a further example in which a plurality of circulator flow guides 30A are provided for a single seal. The flow guides 30A are provided in series, e.g. in flow series, such that a downstream flow guide in the global/leakage flow direction receives flow from an upstream flow guide. Each flow guide 30A is spaced by a fin 24, e.g. such that each flow guide is located in its own flow cavity. Each flow guide 30A is located between a plurality of successive pairs of fins 24, 26. The fin and flow guide structure may otherwise be as described above. Any, or any combination, of the cavities of a labyrinth seal may contain a flow guide of the kind described herein.

As can also be seen in FIG. 8, the step formation(s) 40A in the opposing surface 28 are curved in form so as to further promote the vortical flow at vortex H shown in FIG. 7. Such a curved/profiled step formation may be used in any example of the invention to promote recirculating flow and/or to direct flow towards an inlet of the vortical flow path/guide member.

Turning to FIG. 9, there is shown a further example of a flow guide member 30B. Like numbers are given like reference numerals and will not be described again.

In the example of FIG. 9, the flow guide 30B is located closer to (e.g. adjacent) the upstream fin 24, instead of the downstream fin 26, of the pair of fins. The flow guide 30B again acts as a flow diode but its shape is modified to suit its position in the flow cavity.

The flow guide has a surface facing the downstream surface of the upstream fin 24. These opposing surfaces are correspondingly shaped and spaced so as to define the flow path 37 there-between.

The flow guide 30B is bulbous towards its inlet end and narrows/tapers towards its outlet end. Unlike the other embodiments, the inlet of the flow path 37 is radially inside the outlet. Also the inlet of the flow path 37 is downstream of the outlet in a global flow direction from left to right as shown in FIG. 9.

In the example of FIG. 9, as a higher velocity flow passes through the gap between the fin 24 and the opposing surface 28 it is directed to the step formation 40A, which may be curved as described above. The step 40A redirects the flow towards the flow path 37 inlet in the direction of arrow K. This promotes the recirculating flow akin to the recirculation H shown in FIG. 7.

The recirculating flow then passes along the flow path 37 and exits adjacent the fin tip 24A, where it meets the main leakage flow through the gap. The main leakage flow through the gap then turns the flow exiting the flow path 37 back towards the step 40A. Thus some energy of the main leakage flow is beneficially lost in turning the recirculating flow exiting the passage 37.

Any flow exiting the vortical flow regime passes towards the downstream fin 26. In this example, the intermediate surface between the upstream 24 and downstream 26 fins is profiled so as to promote the two distinct recirculations H and G shown in FIG. 7. The intermediate surface is curved. In particular the intermediate surface is curved towards an apex or tip formation 39 arranged part-way between the fins 24 and 26. The opposing apex 39 and step formation 40A thus serve to delineate between the two vortices H and G established in the space between the fins 24 and 26.

The fins 24 and/or 26 in the example of FIG. 9 may be curved so as to further promote the desired flow regime. Any fin according to different examples of the invention may have a concave upstream surface and/or convexly curved downstream surface.

In other examples of the invention, the flow guide 30B could be provided adjacent upstream fin 24 and the flow guide member 30A could be provided in the same flow cavity but adjacent the downstream fin 26, e.g. such that each flow guide promotes its own respective vortex H and G.

Furthermore, it has been found that aspects of the modified geometry disclosed herein for any, any combination, or all, of the step 40A, the profiled fin(s) and/or the intermediate wall between the fins may help to promote the desired vortical flow regime even without the presence of the flow diode. The modified wall geometry may be used to promote a single or dual vortex regime of the types described above. The formation 37 or the enlarged/curved profile of the flow cavity towards the upstream/downstream fin may be useful particularly in the context of a stepped labyrinth seal geometry.

Therefore some aspects of the disclosure may omit the flow guide member 30, 30A or 30B in some or all flow cavities of the labyrinth seal in favour of a modified step and/or modified geometry between the fins. Those features may be used together or in isolation for each flow cavity and so different examples of the disclosure include all combinations of these possible options for each individual flow cavity of the labyrinth seal.

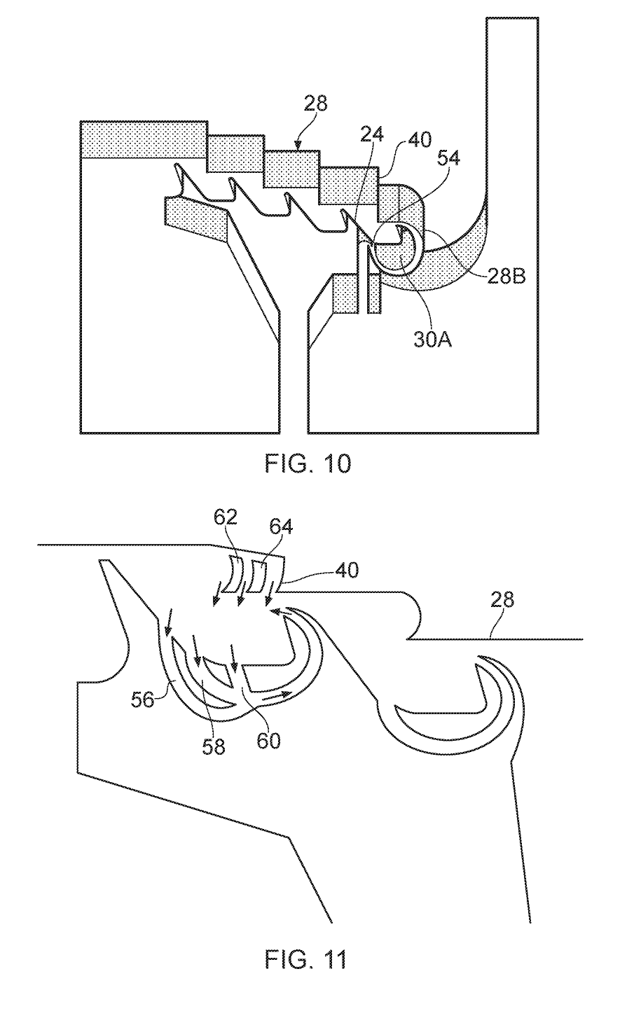

FIG. 10 shows another example which represents a modification of the arrangement of FIG. 6. In the example of FIG. 10, instead of being located between two adjacent fins, the flow guide member 30A is located between a fin and an end wall 28B provided in the opposing surface 28. Thus the flow guide 30A can be mounted on the opposing surface/stator structure.

The wall portion 28B may take the form described above in relation to the surface portion 28A above. However in this example the wall portion 28B has been brought closer to the flow guide 30A such that the downstream fin 34 can be dispensed with and the circulator flow passage is instead provided between the flow guide 30A and the wall portion 28B of the opposing surface (i.e. the stator surface in this example).

In the example of FIG. 10, the upstream fin 24 terminates upstream of the flow guide 30A to provide a flow gap 54 which provides the inlet gap into the circulator flow. The flow from the step 40 of the opposing surface 28 is thus directed to the flow gap 54 and promotes vortical flow around the flow guide 30A (i.e. between the flow guide 30A and end wall 28B.

The exit from the circulator is tucked behind the downstream end/edge of the upstream fin 24, i.e. adjacent flow gap 54, such that the flow needs to turn a sharp corner around the end/edge to exit the seal. The exhaust flow of the flow guide passage is part of the main seal passage.

In FIG. 11 there is shown another example which is based on the examples of FIG. 5 or 8 but with features to accommodate potential relative axial movement between the rotor and stator. This arrangement is as described hereinabove but comprises a plurality or series of circulator inlets 56, 58, 60 spaced in an axial direction. The inlets are spaced by flow diverting formations located between the upstream and downstream fins, e.g. intermediate guides or circulator wall sections, to direct the flow along the circulator flow path. The geometry of the circulator is such that a single circulator outlet gap may be provided that is common to the plurality of inlets.

Also shown as an optional additional/alternative feature is the provision of a plurality/series of axially spaced flow diverting formations for guiding flow from the opposing/stator surface 28 towards the circulator inlet(s). Those flow diverters may comprise additional guides 62, 64 as well as the step surface 40 in the opposing surface 28. Any combination of multiple stator exit flow diverters and/or circulator inlet flow diverters could be used depending on a predicted axial displacement/tolerance range.

The principle of providing a vortex-promoting flow diverting formations is common to the above examples of the disclosure. Aspects of the disclosure may thus reside in the provision of a flow diverter, e.g. a flow guide passage, having a leading or trailing edge that is oriented to direct flow substantially tangentially with respect to the vortex established by flow through the cavity immediately downstream of a seal fin.

Within examples of the disclosure, the flow guide 30, 30A will typically be connected/mounted to the supporting rotor or stator component (i.e. to the seal body 44 or opposing surface 28 via a plurality of discrete vanes. An array of vanes would typically be spaced about the axis of rotation 11 of the rotor. The design of the vanes could be such that they do not significantly alter the flow's pressure or energy. In future developments, the vanes could also be designed to provide a compressor function, e.g. to add energy to the flow, either to increase or retard flow through the circulator flow passage.

It is noted that the seal (i.e. fin and/flow guide) structure could be 3D printed, if required, alongside other, more-conventional manufacturing techniques.

The seal could be manufactured by machining the fins separately from the rotor and fastening/bolting them together. Suitable machined islands could be welded or fastened to the fins. Alternatively the whole geometry could be cast and the relevant passage void(s) could be melted, machined or drilled from the cast product. Thus, examples which include the islands may be manufactured using conventional techniques. Alternatively, additive layer manufacture could be used to form the whole of the seal, or a part thereof. Furthermore, examples that omit a flow diode/island may be manufactured using conventional techniques.

Whilst examples of seal geometry are described above for a labyrinth seal construction, this may not be essential in other examples, provided the seal geometry is capable of producing the described vortex flow loss mechanisms and/or fin tip separation enhancement.

It will be understood that the invention is not limited to the embodiments above-described and various modifications and improvements can be made without departing from the concepts described herein. Except where mutually exclusive, any of the features may be employed separately or in combination with any other features and the disclosure extends to and includes all combinations and sub-combinations of one or more features described herein.

1. A flow seal for location between a first component and a second component of a fluid flow machine, the flow seal comprising:
a flow cavity formed between an upstream fin and a downstream wall; wherein
the upstream fin extends from the first component towards an opposing surface of the second component and terminates at a fin tip to define an upstream inlet gap through which, during use, a leakage fluid enters the cavity; and,
the downstream wall is configured downstream of the fin and extends from one of components towards an opposing surface of the other of the components to define a downstream outlet gap through which, during use, the leakage fluid exits the cavity;
the seal further comprising a flow guide member configured within the cavity to define, in use, a leakage fluid flow path that both:
a) promotes vortical flow of the leakage fluid within the cavity, and
b) directs the leakage fluid towards the upstream inlet gap to at least partially reduce the quantity of leakage fluid entering the cavity.

2. The flow seal of claim 1, wherein the downstream wall comprises a downstream fin depending from a common support structure as the upstream fin.

3. The flow seal of claim 1, wherein the wall comprises a wall section of the opposing surface.

4. The flow seal of claim 1, wherein the wall at least partially surrounds the flow guide member.

5. The flow seal of claim 1, wherein the flow guide member is spaced from the fin or wall so as to define the flow path between the flow guide member and the fin or wall, the leakage fluid flow path being oriented tangentially to the vortical flow in the cavity and having an outlet arranged so as to feed the vortical flow with flow exiting the leakage fluid flow path.

6. The flow seal of claim 5, wherein the flow path is partially concentric with the vortical flow in the cavity.

7. The flow seal of claim 5, wherein the flow path is elongate in section and has the outlet and inlet gap at an opposite end thereof to the outlet gap, the inlet gap being offset from the outlet gap relative to the opposing surface.

8. The flow seal of claim 5, wherein the flow path turns through an angle of at least 90° about a centre of the vortical flow in the cavity.

9. The flow seal of claim 1, wherein the opposing surface comprises a step formation part way along the flow cavity, the step formation being curved in form and extending in a direction generally tangentially of the vortical flow in the cavity.

10. The flow seal of claim 1 wherein the flow guide member has a convex outer surface and a concave opposing outer surface.

11. The flow seal of claim 1, wherein the flow guide member comprises a flow diode.

12. The flow seal of claim 1, wherein the flow guide member and either or both of the wall or fin are correspondingly curved.

13. The flow seal of claim 1, wherein the flow guide member has width and height dimensions in section, each of which are less than or equal to the corresponding width and height dimensions of the cavity.

14. A flow seal for location between rotor and stator components of a fluid flow machine, the flow seal comprising:
a plurality of adjacent fins depending from a common support structure of one of the rotor and stator towards an opposing surface of the other of the rotor and stator, each fin terminating at a fin tip so as to define an upstream inlet gap and a downstream outlet gap,
wherein fluid flow through the upstream inlet gap causes flow separation resulting in a vortical flow in a flow cavity between the adjacent fins, the seal further comprising a flow guide member configured within the cavity between the adjacent fins to define, in use, a leakage fluid flow path that both
a) promotes vortical flow of the leakage fluid within the cavity, and
b) directs the leakage fluid towards the upstream inlet gap to at least partially reduce the quantity of leakage fluid entering the cavity.

15. A flow seal for location between opposing components of a fluid flow machine, comprising:
a first component of the flow seal having an upstream fin, a downstream fin and an intermediate surface extending between the upstream and downstream fins, the upstream and downstream fins extending from the intermediate surface towards an opposing surface of a second component of the flow seal,
wherein the upstream and downstream fins terminate at respective fin tips so as to define an upstream inlet gap and a downstream outlet gap between the respective fin tips and the opposing surface, such that a leakage fluid flowing through the flow seal passes through each said gap in use,
and wherein the opposing surface comprises a flow diverting formation configured between the upstream and downstream fins of the first component to divert the leakage fluid towards the intermediate surface, the intermediate surface comprising a corresponding formation that, in use, either or both of:
a) promotes vortical flow of the leakage fluid in the space between the upstream and downstream fins, and
b) directs the leakage fluid towards the upstream inlet gap to at least partially reduce the quantity of leakage fluid entering the cavity.

16. A flow seal according to claim 15, wherein the corresponding formation comprises a projection between the upstream and downstream fins.

17. A flow seal according to claim 16, wherein the projection is curved or sloped towards an apex, and wherein an upstream side of the downstream fin is curved to oppose a curve of the intermediate surface towards the apex.

18. A flow seal according to claim 16, wherein the intermediate surface is opposingly curved or sloped on either side of the formation.

19. A flow seal according to claim 15, wherein the flow diverting formation comprises a corner pointing towards the corresponding formation of the first component.

20. Turbomachinery comprising the flow seal of claim 1.
